(19) United States
(12) Patent Application Publication
(10) Pub. No.: US 2005/0161858 A1
(43) Pub. Date: Jul. 28, 2005

(54) Method to improve melt processing of styrenic resins at high shear rates

(76) Inventors: Cyril Chevillard, Dickinson, TX (US); Jose M. Sosa, Deer Park, TX (US)

Correspondence Address: FINA TECHNOLOGY INC, PO BOX 674412, HOUSTON, TX, 77267-4412, US

(21) Appl. No.: 10/766,672

(22) Filed: Jan. 28, 2004

(51) Int. Cl. B29C 47/00

(52) U.S. Cl. 264/176.1; 525/241

(57) ABSTRACT

It has been discovered that the melt instability of styrenic polymers, particularly high impact polystyrene (HIPS) can be reduced or eliminated by the blending therewith of a relatively high melt flow index (MFI) material, such as polystyrene homopolymer. Draw resonance of the melt blend can also be reduced by this method, thereby improving melt processing of these materials. A method to measure melt instability of drawn materials is also discussed.

### FIELD OF THE INVENTION

The present invention is related to methods and compositions useful to improve the manufacture of products made with styrenic resins. It relates more particularly to methods of melt blending resins with different melt flow indexes that yield extruded products with improved properties.

### BACKGROUND OF THE INVENTION

The polymerization of styrene is a very important industrial process that supplies materials used to create a wide variety of polystyrene-containing articles. This expansive use of polystyrene results from the ability to control the polymerization process. Thus, variations in the polymerization process conditions are of utmost importance since they in turn allow control over the physical properties of the resulting polymer. The resulting physical properties determine the suitability of polystyrene for a particular use. For a given product, several physical characteristics must be balanced to achieve a suitable polystyrene material. Among the properties that must be controlled and balanced are average molecular weight (Mw) of the polymer, molecular weight distribution (MWD), melt flow index (MFI), and the glass transition temperature (T_{g}).

U.S. Pat. No. 5,540,813 by Sosa, et. al., which is incorporated herein by reference, discloses a process for preparing monovinyl aromatic polymers, such as polystyrene, which utilizes a combination of sequentially ordered multiple reactors, heat exchangers and devolatilizers to strictly control polymer properties such as the MWD and MFI.

Extrusion of thermoplastic resins at shear rates from 1,000-15,000 inverse seconds is known to exhibit problems with draw resonance and melt fracture. Draw resonance is related to the speed at which a material is drawn and it often leads to thickness variations and melt instabilities. Draw resonance is a phenomenon in which a molten resin extruded from a die shows a periodic change in a thickness in a flow direction (machine direction or MD) and causes an acceleration in uneven stretching brought about in cold stretching. Draw resonance can be understood as an uncontrolled vibration of the extrudate. Melt fracture relates to surface imperfections produced as materials exit capillaries or dies. Melt fracture can be understood as undesirable long-wavelength undulations in the surface of the extrudate, which can actually break at high velocities. Both draw resonance and melt fracture can lead to thickness variations, melt instabilities, and poor surface qualities of extrudate products. Both melt fracture and draw resonance limit the rates at which materials can be processed. Generally, it is preferred and more cost effective to extrude and process materials as fast as possible, thus reducing these problems at high shear rates can provide a better product at a lower cost.

Styrenic resins, used as cap layers, extruded onto either foam or rigid substrates are know to exhibit draw resonance, which leads to thickness variations. Both polystyrene (PS) and high impact polystyrene (HIPS; containing a rubber phase such as polybutadiene) resins are known to exhibit both melt fracture and draw resonance when processed at high-speeds.

It would be desirable if methods and compositions could be devised or discovered to provide vinylaromatic polymers with improved melt processing at high speeds. It would also be helpful if a method could be devised that would help optimize the processing properties of vinylaromatic polymers without adversely affecting the other physical properties of the vinylaromatic polymer materials and products. Other physical properties that must be maintained within acceptable specifications, or be improved, include but are not necessarily limited to, melt flow, flexural strength, melt strength, Izod and gloss. Such polymers may have a higher melt strength than polymers with linear chains, and may improve processability and mechanical properties of the final product, or at least not adversely affect other physical properties while improving processing characteristics.

### SUMMARY OF THE INVENTION

There is provided, in one form, a method for producing an improved copolymerized product that involves melt blending together at least one relatively low MFI HIPS resin and at least one relatively high MFI polystyrene homopolymer resin to give a melt blend. The melt blend is then extruded to give a product.

In another embodiment of the invention, there is provided a styrenic resin blend that includes at least one relatively low MFI HIPS resin and at least one relatively high MFI polystyrene homopolymer. In another non-limiting embodiment, the invention concerns a laminated article made using this styrenic resin blend.

In an alternate embodiment of the invention, there is provided an improved product made by the process involving melt blending together at least one relatively low MFI HIPS resin and at least one relatively high MFI polystyrene homopolymer to give a melt blend. The melt blend is extruded to give the product having improved processing characteristics.

### BRIEF DESCRIPTION OF THE DRAWINGS

FIG. 1 is a graph of drawing force as a function of the drawing speed for a HIPS resin demonstrating draw resonance;

FIG. 2A is a graph showing plots of melt strength as a function of the % of high MFI polystyrene blended with four different HIPS materials;

FIG. 2B is a graph showing plots of instability Kappa as a function of the % of high MFI polystyrene blended with four different HIPS materials;

FIG. 3A is a graph comparing plots of Izod values as a function of the amount of high MFI polystyrene blended with four different HIPS materials;

FIG. 3B is a graph comparing plots of flexural strength as a function of the amount of high MFI polystyrene blended with four different HIPS materials;

FIG. 4A is a graph comparing plots of MFI of the melt blends as a function of the amount of high MFI polystyrene blended with four different HIPS materials; and

FIG. 4A is a graph comparing plots of gloss values of the melt blends as a function of the amount of high MFI polystyrene blended with four different HIPS materials.

### DETAILED DESCRIPTION OF THE INVENTION

In the present invention, a method has been discovered for improving the processability of HIPS resins by reducing melt instabilities, while at the same time maintaining key mechanical properties of the extruded material. It was found that draw resonance in HIPS is affected primarily by molecular weight, and the levels of mineral oil and rubber, among other factors. In one non-limiting embodiment, the rubber phase of HIPS is polybutadiene. The extrudate products with which this invention is concerned are film laminates where high extrusion speed is required.

It is not considered desirable to change the viscoelastic response of the resin by lowering the rubber content since other properties such as Izod, ductility and melt strength may be undesirably affected. On the other hand, increasing the amount of oil plasticizer is objectionable because higher levels of plasticizer adversely affect bubble growth in foam applications.

A method of reducing melt instabilities and thus improving processing characteristics was discovered that involves adding various levels of a relatively high melt flow index (MFI) material to HIPS having a relatively lower MFI and having optionally relatively lower rubber and oil levels. In the context of this invention, it should be understood that in any particular melt blend the relatively high MFI material has a higher MFI than the relatively lower MFI HIPS resin. This addition of a lower molecular weight crystal resin leads to a material with a bimodal molecular weight distribution of the polystyrene matrix. It is anticipated that intentionally producing a bimodal molecular weight HIPS resin would give the benefits of this invention as well.

In one non-limiting embodiment of the invention, the HIPS material may be a polydiene-modified monovinyl aromatic polymer, and can comprise a rubber-modified polystyrene. Styrene monomer can be polymerized in the presence of from about 2 to about 15 weight percent rubber to produce a polymer having impact resistance superior to that of polystyrene homopolymer. As previously noted, a rubber that can be used in making the subject compositions is polybutadiene. The resultant thermoplastic composition, which can be made with these materials, is HIPS. The predominant morphology of these polymers is cell or “salami” with some core-shell, meaning that the continuous phase of polystyrene comprises a plurality of dispersed structures in which polystyrene is trapped within rubber particles having a distinct membrane and small quantities of polystyrene are occluded inside single cell polybutadiene shells grafted to the aromatic polymer.

Styrene polymerization processes are well known. The HIPS compositions of the invention can be made by batch polymerization in the presence of from about 2 to 15, and in some embodiments can be made from about 4 to about 12, weight percent polybutadiene using conventional initiators at concentrations of from about 100 to about 800 ppm and using a solvent. Hydroperoxide and peroxydicarbonate, peroxyester, peroxyketal, dialkyl peroxide initiators useful in making the invention include peroxide initiators having a half-life of one hour at 110-190° C., including, but not necessarily limited to, 1,1-di-(t-butylperoxy)cyclohexane (LUPERSOL® 331 or L-331 available from ATOFINA Chemicals, Inc.); 1,1-di-(t-amylperoxy)cyclohexane (LUPERSOL® 531 or L-531 available from ATOFINA Chemicals, Inc.); ethyl-3,3-di(t-butylperoxy)butyrate (LUPERSOL® 233 or L-233 available from ATOFINA Chemicals, Inc.); t-amyl peroxy-2-ethylhexyl carbonate (TAEC), t-butylperoxy isopropyl carbonate (TBIC), t-butyl perbenzoate; 1,1-di-(t-butylperoxy)-3,3,5-trimethyl-cyclohexane (LUPERSOL® 231 or L-231 available from ATOFINA Chemicals, Inc.); ethyl-3,3-di(t-amylperoxy)butyrate (LUPERSOL® 533 or L-533), and di-isopropyl benzene monohydroperoxide (DIBMH).

Suitable solvents include, but are not necessarily limited to, ethylbenzene, xylenes, toluene, hexane and cyclohexane. Accelerators can be optionally used to accelerate the rate of polymerization as described in U.S. patent application Ser. No. 10/379,052 filed Mar. 4, 2003, incorporated by reference herein.

In making the certain compositions of the invention, batch polymerizations can be conducted in 97:3 to 91:9 styrene to rubber ratio, 85:15 to 80:20 typical styrene to solvent mixtures to give 60-80% styrene conversion to polystyrene and then flashing off the unreacted monomer and the solvent. In a non-limiting, typical preparation, 3-12% of rubber is dissolved in styrene, then about 10% ethylbenzene is added as 90:10 styrene:ethylbenzene. The ethylbenzene diluent could include solvent, but have other components present as well. A possible temperature profile to be followed in producing the subject compositions is about 110° C for about 120 minutes, about 130° C. for about 60 minutes, and about 150° C. for about 60 minutes. The polymer is then dried and devolatilized by conventional means. Although batch polymerizations are used to describe the invention, the reactions described can be carried out in continuous units, as the one described by Sosa and Nichols in U.S. Pat. No. 4,777,210, incorporated by reference herein.

In one non-limiting embodiment of the invention, the amorphous, relatively low MFI HIPS may have a MFI ranging from about 1.5 to about 15, and in alternate, non-binding embodiment of the invention a MFI ranging from about 1.5 to about 4. Alternatively, or in addition to the MFI ranges previously given, the HIPS may have a Z average molecular weight, Mz, ranging from about 300,000 to about 600,000 Mz and in another non-limiting embodiment of the invention has a Mz ranging from about 380,000 to about 450,000. The HIPS resins should also have a gloss (measured at 60°), ranging from about 50 to 100 and in another non limiting embodiment of the invention has a gloss ranging from 75 to about 85.

In another non-limiting embodiment of this invention, the relatively high MFI polystyrene homopolymer may have a MFI ranging from about 20 to about 40, and in alternate, non-binding embodiment of the invention a MFI ranging having a lower limit of about 30 and/or an upper limit about 35.

In the context of this invention the weight ratio of HIPS resin to polystyrene crystal resin ranges from about 90/10 to about 50/50 In an alternate non-limiting embodiment of the invention the weight ratio of HIPS resin to polystyrene crystal resin ranges from about 10% to about 30%. The resins of this invention may be melt blended using the standard techniques for thermoplastics and no specialized equipment is expected to be required for effective blending. Mixers, extruders or kneaders may be used. The films, tapes, laminates or threads are manufactured either by extrusion casting or by the blow extrusion of a tubular film.

In the context of this invention, suitable rubbers in the HIPS include, but are not necessarily limited to those made from monomers including butadiene, isoprene, and the like. Lubricants useful in the HIPS component of the invention include, but are not necessarily limited to mineral oils, silicone oils, and the like.

The melt instability was measured using a capillary rheometer (e.g. a Rosand capillary rheometer) with a melt drawing apparatus. To quantify the melt instability the difference ratio of the Upper and Lower Prediction Limit for a sample relative to the same limits for a well known, control material was calculated and was identified as “Instability Kappa” or K.

$${κ}_{sample} = \frac{{UPL}_{sample} - {LPL}_{sample}}{{UPL}_{control} - {LPL}_{control}} \qquad ( Equation 1 )$$

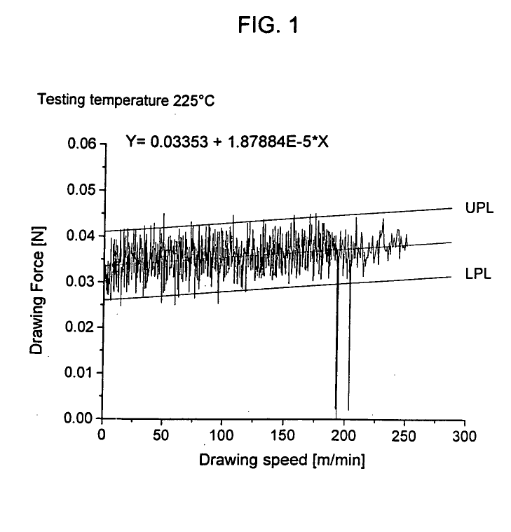

The Upper Prediction Limit (UPL) and Lower Prediction Limit (LPL) were calculated for a confidence interval that ranged from 95% to 99% and extrapolated at a drawing speed equal to zero. The control material chosen was one that was readily available and which had a relatively high melt instability. To give a better understanding of Kappa (K), FIG. 1 is presented for a particular HIPS material not necessarily part of this invention. The greater the melt instability, the wider the swings in the drawing force between the UPL and LPL as shown in a graph like that of FIG. 1. In a plot such as that of FIG. 1, the drawing speed increases until the material breaks. The value of Kappa for the HIPS resin of FIG. 1 is 0.813319. For Kappa=1 the resin is considered the most unstable and for Kappa=0 the resin is considered the most stable. Thus, the resin of FIG. 1 is relatively unstable.

Table 1 below shows the resins selected and the level of a high MFI material, designated PS-A (MFI=30), added to four different HIPS resins. As shown in Table 1, a decrease of the instability Kappa was found with 10% and higher of the high MFI polystyrene homopolymer. The drawing test was performed at 225° C., 10 s⁻¹ with an acceleration of 1 m/min/sec and a drawing speed from 0 to 300 m/min. It was also observed that in presence of high melt flow polystyrene crystal the melt flow and flexural strength increase, the melt strength and Izod decrease and the gloss is not affected.

TABLE 1
Mechanical Testing Performed on Selected Blends

| | | Ratio, % | Izod | | Flexural strength | | Flexural Modulus | | Gloss, | MFI, | | Melt |
|---|---|---|---|---|---|---|---|---|---|---|---|---|
| Ex. | HIPS | HIPS/PS-A | ft-lb/in | J/m | psi | Pa, ×10⁷ | psi, ×10⁵ | Pa, ×10⁹ | 60° | g/10 min | κ | strength, N |
| 1 | HIPS-B | 100/0 | 1.36 | 72.6 | 8631 | 5.95 | 3.75 | 2.59 | 81 | 4.23 | — | — |
| 2 | HIPS-B | 70/30 | 0.85 | 45.4 | 8869 | 6.11 | 3.87 | 2.67 | 49.5 | 7.536 | 0.263 | 0.0162 |
| 3 | HIPS-B | 50/50 | 0.65 | 34.7 | 10029 | 6.91 | 4.05 | 2.79 | 81.9 | 12.039 | 0.221 | 0.01269 |
| 4 | HIPS-B | 60/40 | 0.74 | 39.5 | 9385 | 6.47 | 3.94 | 2.72 | 81.1 | 10.406 | 0.16 | 0.010075 |
| 5 | HIPS-B | 80/20 | 0.99 | 52.9 | 8631 | 5.95 | 3.75 | 2.59 | 77.9 | 6.251 | 0.217 | 0.00849 |
| 6 | HIPS-A | 100/0 | 2.11 | 112 | 7965 | 5.49 | 3.67 | 2.53 | 85 | 2.54 | 0.355 | 0.03556 |
| 7 | HIPS-A | 70/30 | 0.78 | 41.6 | 9285 | 6.40 | 3.91 | 2.70 | 80.3 | 7.069 | 0.201 | 0.0174 |
| 8 | HIPS-A | 50/50 | 0.68 | 36.3 | 9749 | 6.72 | 4.00 | 2.76 | 83.4 | 9.121 | 0.242 | 0.0149 |
| 9 | HIPS-A | 60/40 | 0.62 | 33.1 | 10363 | 7.14 | 4.09 | 2.82 | 81.4 | 11.401 | 0.2 | 0.01194 |
| 10 | HIPS-A | 80/20 | 1.01 | 53.9 | 8981 | 6.19 | 3.84 | 2.65 | 42.4 | 5.371 | 0.223 | 0.01046 |
| 11 | HIPS-D | 100/0 | 1.57 | 83.8 | 7790 | 5.37 | 2.85 | 1.96 | 60 | 1.69 | 0.497 | 0.04326 |
| 12 | HIPS-D | 70/30 | 1.1 | 58.7 | 8607 | 5.93 | 3.23 | 2.23 | 44.6 | 4.844 | 0.415 | 0.022368 |
| 13 | HIPS-D | 50/50 | 0.73 | 39.0 | 9762 | 6.73 | 3.61 | 2.49 | 45.2 | 9.125 | 0.229 | 0.01689 |
| 14 | HIPS-D | 60/40 | 0.9 | 48.1 | 9278 | 6.40 | 3.42 | 2.36 | 38.3 | 7.038 | 0.297 | 0.01344 |
| 15 | HIPS-D | 80/20 | 1.29 | 68.9 | 8211 | 5.66 | 3.03 | 2.09 | 42.4 | 3.621 | 0.162 | 0.0093 |
| 16 | HIPS-C | 100/0 | 1.9 | 101 | 10009 | 6.90 | 3.70 | 2.55 | 75 | 2.602 | 0.497 | 0.03318 |
| 17 | HIPS-C | 70/30 | 0.99 | 52.9 | 10467 | 7.22 | 3.82 | 2.63 | 78.4 | 5.723 | 0.306 | 0.01974 |
| 18 | HIPS-C | 50/50 | 0.69 | 36.8 | 10991 | 7.58 | 4.06 | 2.80 | 81.4 | 9.444 | 0.206 | 0.01575 |
| 19 | HIPS-C | 60/40 | 0.85 | 45.3 | 10874 | 7.50 | 3.89 | 2.68 | 74.4 | 6.697 | 0.254 | 0.01387 |
| 20 | HIPS-C | 80/20 | 1.13 | 60.3 | 10009 | 6.90 | 3.70 | 2.55 | 75.2 | 4.099 | 0.142 | 0.0105 |

The resins HIPS-A, HIPS-B, HIPS-C and HIPS-D are all relatively low MFI HIPS resins available from ATOFINA that fall within the definitions of the invention for these materials.

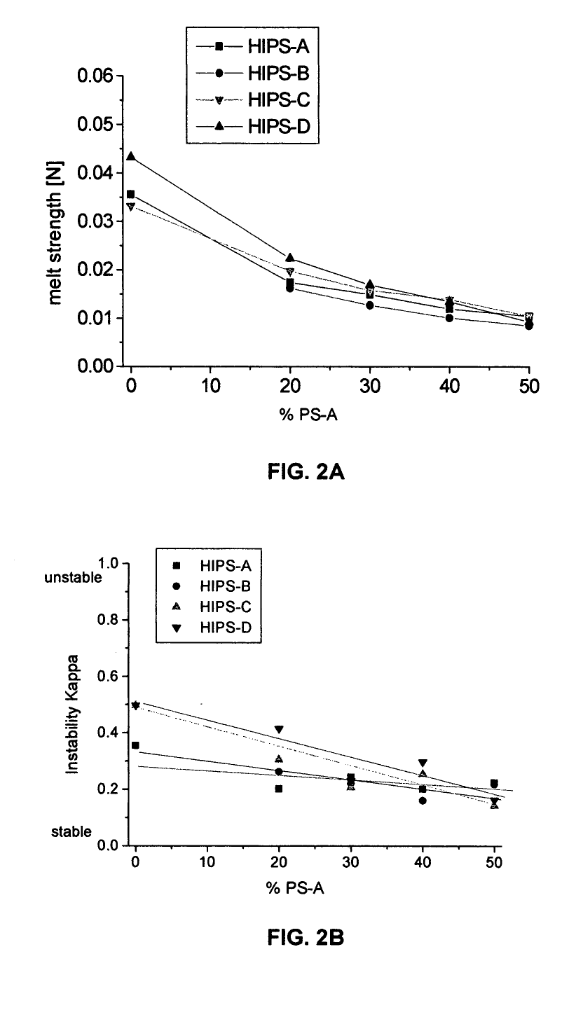

The results of the Examples in Table 1 are plotted in FIGS. 2-4. FIG. 2a is a plot of melt strength as a function of the % of high MFI material PS-A combined with the indicated HIPS material. It may be seen that as the amount of PS-A increases, the melt strength decreases. Importantly, FIG. 2B demonstrates that the instability Kappa decreases with increasing high MFI proportion showing that adding the high MFI material desirably stabilizes the melt and reduces draw resonance and melt fracture.

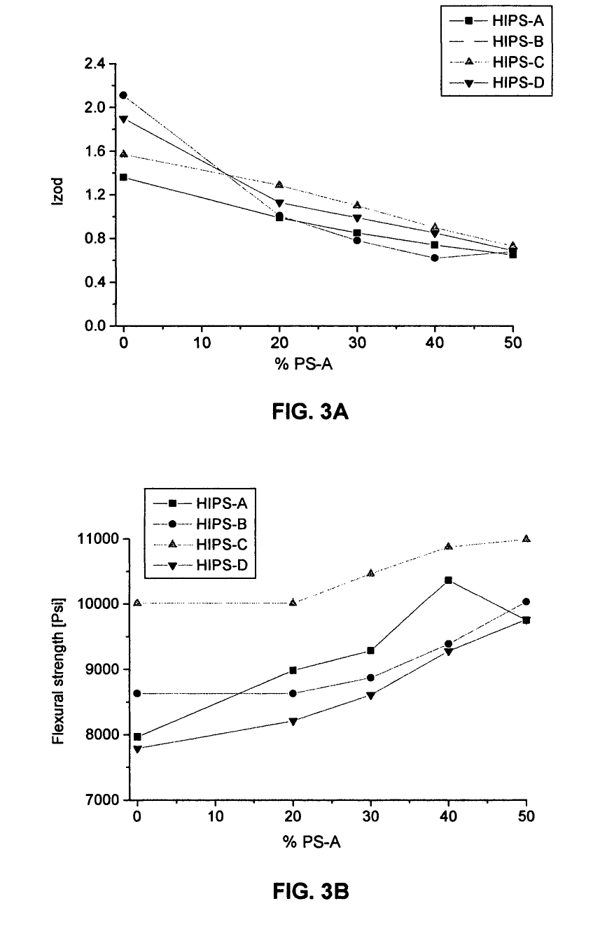

Shown in FIG. 3A are plots of Izod as a function of the amount of PS-A material in the melt blend with each of the four HIPS materials. Generally, the Izod decreases with increasing proportion of high MFI material. FIG. 3B presents the plots of flexural strength as a function of high MFI material proportion demonstrating that flexural strength increases with increasing PS-A amount.

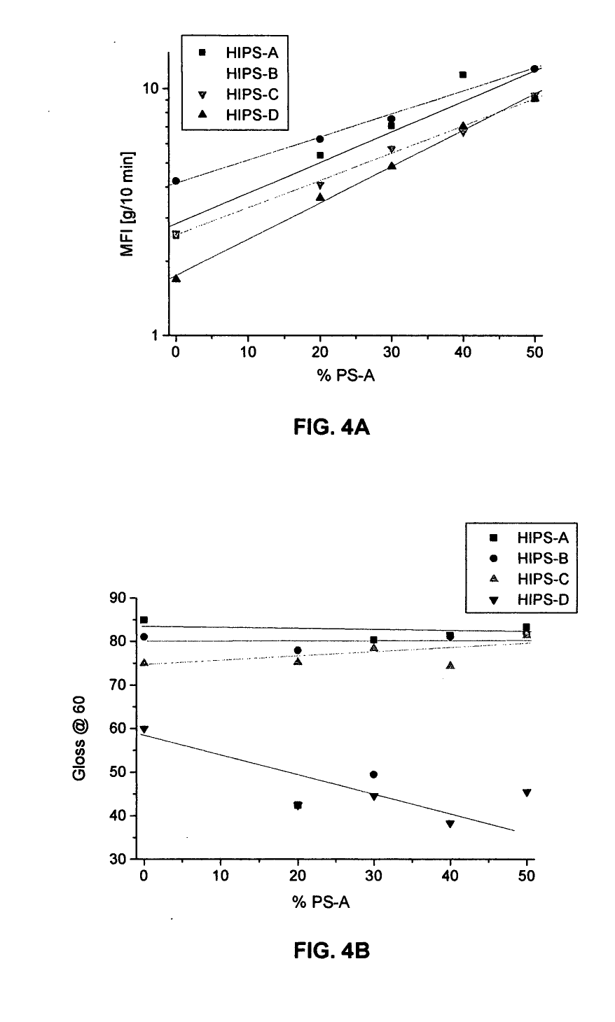

In FIG. 4A are plotted the results of MFI as a function of increasing high MFI proportion in the melt blend; not surprisingly, the MFI increases with increasing PS-A proportion. Finally, the gloss results as a function of increasing high MFI material proportion in the melt blend are presented in FIG. 4B. It can be seen that the gloss values were generally unchanged except for the case of ATOFINA PS HIPS-D polystyrene, which decreased with increasing high-MFI proportion.

The styrene-based polymers of the present invention may be widely and effectively used as materials for injection molding, extrusion molding or sheet molding. It is also expected that the polymer resins of this invention can be used as extrusion and molding materials in the fields of various different products, including, but not necessarily limited to, household goods, electrical appliances and the like.

In the foregoing specification, the invention has been described with reference to specific embodiments thereof, and has been demonstrated as effective in providing methods for preparing styrenic polymers by blending materials with different melt flow indexes together. However, it will be evident that various modifications and changes can be made thereto without departing from the scope of the invention as set forth in the appended claims. Accordingly, the specification is to be regarded in an illustrative rather than a restrictive sense. For example, specific combinations or amounts of vinylaromatic resins, copolymer resins and high MFI materials, and other components falling within the claimed parameters, but not specifically identified or tried in a particular polymer system, are anticipated and expected to be within the scope of this invention. Further, the methods of the invention are expected to work at other conditions than those exemplified herein, particularly temperature, pressure and proportion conditions.

1. A method for producing an improved copolymerized product comprising:
melt blending together to give a melt blend:
at least one relatively low MFI HIPS resin; and
at least one relatively high MFI polystyrene homopolymer; and
extruding a product from the melt blend.

2. The method of claim 1 where the HIPS resin has a MFI ranging from about 1.5 to about 15, and the polystyrene homopolymer has a MFI ranging from about 20 to about 40.

3. The method of claim 1 where the weight ratio of HIPS resin to polystyrene homopolymer ranges from about 90/10 to about 50/50.

4. The method of claim 1 where the product has improved melt stability as compared with a product made from the relatively low MFI HIPS resin without the relatively high MFI polystyrene homopolymer.

5. The method of claim 1 where the product is extruded at a shear rate from about 1,000 to about 15,000 s⁻¹.

6. A method for producing an improved copolymerized product comprising:
melt blending together to give a melt blend:
at least one HIPS resin having a MFI ranging from about 1.5 to about 15; and
at least polystyrene homopolymer having a MFI ranging from about 20 to about 40;
where the weight ratio of HIPS resin to polystyrene homopolymer ranges from about 90/10 to about 50/50 and
extruding a product from the melt blend.

7. The method of claim 6 where the product has improved melt stability as compared with a product made from the relatively low MFI HIPS resin without the relatively high MFI polystyrene homopolymer.

8. A styrenic resin blend comprising at least one relatively low MFI HIPS resin and at least one relatively high MFI polystyrene homopolymer.

9. The styrenic resin blend of claim 8 where the HIPS resin has a MFI ranging from about 1.5 to about 15, and the polystyrene homopolymer has a MFI ranging from about 20 to about 40.

10. The styrenic resin blend of claim 8 where the weight ratio of HIPS resin to polystyrene homopolymer ranges from about 90/10 to about 50/50.

11. The styrenic resin blend of claim 8 where a product made from the resin blend has improved melt stability as compared with a product made from the relatively low MFI HIPS resin without the relatively high MFI polystyrene homopolymer.

12. A laminated article made with the styrenic resin blend of claim 8.

13. A styrenic resin blend comprising at least one HIPS resin having a MFI ranging from about 1.5 to about 15 and at least one polystyrene homopolymer having a MFI ranging from about 20 to about 40, where the weight ratio of HIPS resin to polystyrene homopolymer ranges from about 90/10 to about 50/50

14. The styrenic resin blend of claim 13 where a product made from the resin blend has improved melt stability as compared with a product made from the relatively low MFI HIPS resin without the relatively high MFI polystyrene homopolymer.

15. A laminated article made with the styrenic resin blend of claim 13.

16. A product made by the process comprising:
melt blending together to give a melt blend:
at least one relatively low MFI HIPS resin; and
at least one relatively high MFI polystyrene homopolymer; and
extruding the product from the melt blend.

17. The product of claim 16 where the HIPS resin has a MFI ranging from about 1.5 to about 15, and the polystyrene homopolymer has a MFI ranging from about 20 to about 40.

18. The product of claim 16 where the weight ratio of HIPS resin to polystyrene homopolymer ranges from about 90/10 to about 50/50.

19. The product of claim 16 where the product has improved melt stability as compared with a product made from the relatively low MFI HIPS resin without the relatively high MFI polystyrene homopolymer.

20. The product of claim 16 where the product is extruded at a shear rate from about 1,000 to about 15,000 s⁻¹.

21. A product made by a process comprising:
melt blending together to give a melt blend:
at least one HIPS resin having a MFI ranging from about 1.5 to about 15; and
at least polystyrene homopolymer having a MFI ranging from about 20 to about 40;
where the weight ratio of HIPS resin to polystyrene homopolymer ranges from about 90/10 to about 50/50 and
extruding the product from the melt blend.

22. The product of claim 21 where the product has improved melt stability as compared with a product made from the relatively low MFI HIPS resin without the relatively high MFI polystyrene homopolymer.

23. A method of measuring the melt instability of an extruded polymer sample according to the Equation 1:
$${κ}_{sample} = \frac{{UPL}_{sample} - {LPL}_{sample}}{{UPL}_{control} - {LPL}_{control}} \qquad ( Equation 1 )$$
where UPL_{control} is the Upper Prediction Limit of a control polymer having high melt instability extrapolated to a drawing speed equal to zero,
LPL_{control} is the Lower Prediction Limit of the control polymer extrapolated to a drawing speed equal to zero,
UPLₛₐₘₚₗₑ is the Upper Prediction Limit of the extruded polymer sample extrapolated to a drawing speed equal to zero, and
LPLₛₐₘₚₗₑ is the Lower Prediction Limit of the extruded polymer sample extrapolated to a drawing speed equal to zero,
where κₛₐₘₚₗₑ closer to 1 indicates a relatively unstable extruded polymer sample and a κₛₐₘₚₗₑ closer to 0 indicates a relatively stable extruded polymer sample.

24. The method of claim 23 where the control polymer and the sample polymer are selected from the group consisting of styrene polymers and styrene copolymers.
